(19) United States
(12) Patent Application Publication
(10) Pub. No.: US 2023/0127617 A1
(43) Pub. Date: Apr. 27, 2023

(54) INFLATABLE ERGONOMIC DECUBITUS POSITIONING SUPPORT FOR MEDICAL USE

(71) Applicant: DIANOSIC, STRASBOURG (FR)

(72) Inventors: Philippe BASTIDE, ISSY-LES-MOULINEAUX (FR); Sébastien FROELICH, PARIS (FR)

(21) Appl. No.: 17/918,044

(22) PCT Filed: Apr. 8, 2021
(86) PCT No.: PCT/FR2021/050618

§ 371 Date: Oct. 10, 2022

(30) Foreign Application Priority Data
Apr. 11, 2020 (FR) 2003677

(51) Int. Cl. A61G 7/057

(52) U.S. Cl. CPC A61G 7/05769; A61G 2200/325

(57) ABSTRACT

An ergonomic inflatable decubitus positioning support for medical use has a central opening, shaped for at least abdominal reception of a patient in ventral decubitus, and an inflatable load-bearing peripheral structure surrounding the central opening. This inflatable load-bearing peripheral structure extends according to a mainly rectangular inflatable shape with two lateral portions and two transversal portions, shaped in such a way that one of the two transversal portions, the so-called upper transversal portion, has at least locally, when the load-bearing peripheral structure is inflated, an inflated cross-section of smaller dimensions than those of the inflated cross-sections of the two lateral portions for an upper thoracic reception of the patient.

The present invention relates to an ergonomic inflatable decubitus positioning support for medical use. Such an inflatable support finds a particularly relevant application in the care of patients in hypoxemic respiratory distress with COVID-19, but can also be useful in other therapeutic or surgical care, monitoring or follow-up applications.

The invention applies more specifically to an ergonomic inflatable support comprising:
a central opening shaped for at least abdominal reception of a patient in ventral decubitus position; and
an inflatable load-bearing peripheral structure surrounding the central opening.

This kind of device is, for example, described in US 2017/0181913 A1 patent application. It comprises an ergonomic inflatable support thoracic cushion of the aforementioned type with a central opening for receiving a thoracic region of the patient. It further requires an inflatable pelvic cushion and other support elements for supporting the patient’s head and ankles.

This document US 2017/0181913 A1 teaches to first position the patient in dorsal decubitus position, then equip him/her with the deflated thoracic and pelvic cushions, then turn him/her in ventral decubitus position before proceeding with the inflation of the cushions. The inflation carried out once the patient is turned over in ventral decubitus on the deflated cushions makes it possible to raise him/her and to position him/her suitably on his/her ergonomic support without effort.

But the proposed device presents a certain complexity because of the multiple elements it provides: thoracic cushion, pelvic cushion, head support, ankle support.

However, in pathologies causing sharp respiratory difficulties, it may be necessary to regularly move or reposition patients to ventral, dorsal, lateral decubitus or other positions, with or without support. The complex device of document US 2017/0181913 A1 is therefore not suitable for such manipulations. It also has a rather poor distribution of pressure areas on the patient’s body. Alternatively, one could think of using an inflatable buoy of oblong shape such as the one for example presented in utility model CN 201912366 U, with a central opening shaped for at least abdominal reception of a patient in ventral decubitus position, because it is simple enough to be suited for repeated repositioning of the patient. But it is not actually designed to his/her morphology, not comfortable, and may even prevent him/her from breathing properly.

It may thus be desirable to provide an ergonomic inflatable decubitus positioning support for medical use which makes it possible to get rid of at least part of the above-mentioned problems and constraints.

It is therefore proposed an ergonomic inflatable decubitus positioning support for medical use with:
a central opening shaped for at least abdominal reception of a patient in ventral decubitus position; and
an inflatable load-bearing peripheral structure surrounding the central opening;
wherein the inflatable load-bearing peripheral structure extends according to a mainly rectangular inflatable shape with two lateral portions and two transversal portions, shaped in such a way that one of the two transversal portions, the so-called upper transversal portion, has at least locally, when the load-bearing peripheral structure is inflated, an inflated cross-section with dimensions smaller than those of the inflated cross-sections of the two lateral portions for an upper thoracic reception of the patient.

Thus, while allowing effortless positioning of the patient in ventral decubitus as in the two aforementioned documents of the prior art, an ergonomic inflatable support according to the present invention has additional technical effects and advantages. The mainly rectangular shape of the load-bearing peripheral structure provides ergonomic lateral supports for the patient’s flanks, thus avoiding a lordosis deformation of the trunk, while the smaller cross-section of the upper transversal portion ensures a better upper thoracic reception, in particular for a better support of his/her chin and of the base of his/her neck.

Furthermore, the distribution of the patient’s weight over a larger surface area than that proposed, for example, in document US 2017/0181913 A1 based on a system with multiple cushions, reduces the pressure exerted on the surfaces in contact and thus the risk of pressure sores during prolonged ventral decubitus positioning. Finally, the ventral position that such a support allows, with central clearance to accommodate the abdomen, itself allows avoiding abdominal compression and its potentially deleterious effects on ventilatory mechanics and venous return. This ventral position also allows a better ventilation of the pulmonary bases.

Optionally, the lateral and transversal portions of the inflatable load-bearing peripheral structure are further shaped in such a way that the other one of the two transversal portions, the so-called lower transversal portion, has at least locally, when the load-bearing peripheral structure is inflated, an inflated cross-section of smaller dimensions than those of the inflated cross-sections of the two lateral portions for reception of inguinal regions of the patient.

Thus, the smaller cross-section of the lower transversal portion provides better reception of the patient’s inguinal regions, including better reception of his/her genitals.

Also optionally, the upper transversal portion presents, when inflated, an indentation or concavity for receiving the bottom of the patient’s neck and chin.

Also optionally, the inflated cross-section of the upper transversal portion has dimensions, at least locally, at least 20%, or even at least 25%, smaller than those of the inflated cross-sections of the two lateral portions.

Also optionally, the central opening has a mainly rectangular shape with a width, bounded by said two lateral portions, at least 25% less than its length, bounded by said two transversal portions.

Also optionally, the inflatable load-bearing peripheral structure comprises at least one inflatable flange and at least one corresponding inflation nozzle disposed and extending away from the central opening.

Also optionally, the inflatable load-bearing peripheral structure comprises a single inflatable flange of mainly rectangular shape and a single inflation nozzle disposed and extending laterally away from the central opening.

Also optionally, the central opening has a mainly rectangular bottom, integral with the inflatable load-bearing peripheral structure, for maintaining the mainly rectangular shape of the latter and for receiving the patient’s abdomen when in ventral decubitus position.

Also optionally, the central opening is dimensioned to accommodate the abdominal and thoracic regions of the patient when in ventral decubitus position.

Also optionally, an ergonomic inflatable support according to the invention can be designed in a transparent plastic material.

The invention will be better understood with the aid of the following description, given solely by way of example and made with reference to the appended drawings wherein:

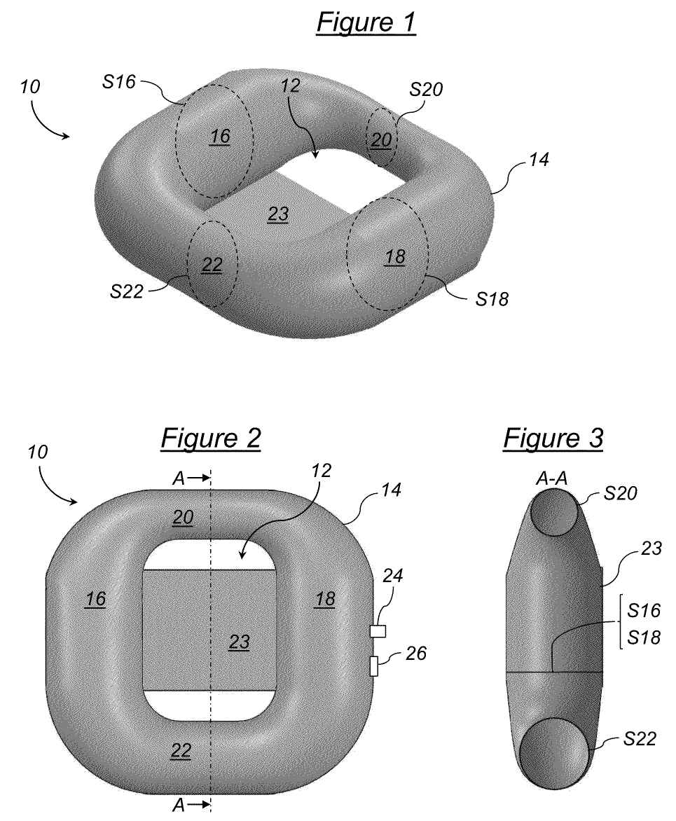

FIG. 1 diagrammatically represents in perspective the general structure of an ergonomic inflatable decubitus positioning support for medical use, according to an embodiment of the invention,

FIG. 2 is an upper view of the ergonomic inflatable support of FIG. 1,

FIG. 3 is a view according to a section A-A of FIG. 2,

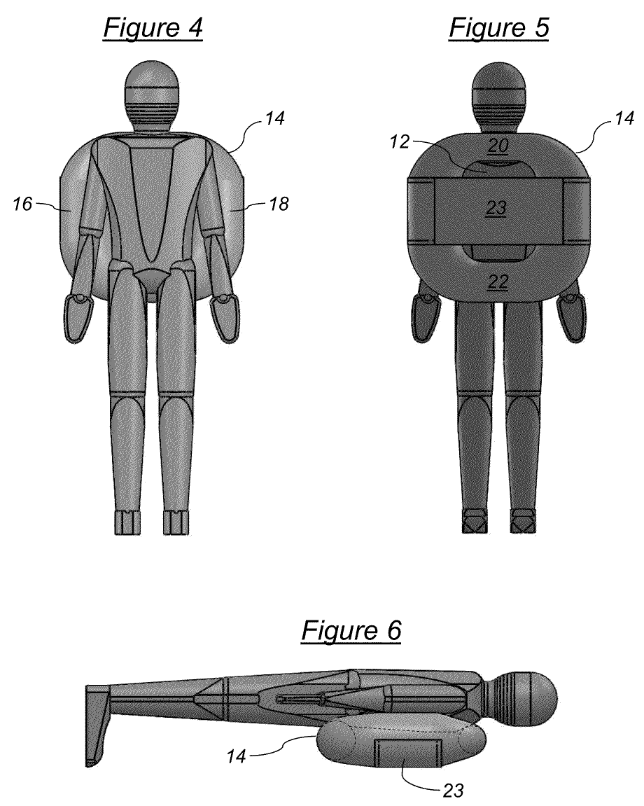

FIG. 4 represents the ergonomic inflatable support in the upper view of FIG. 2 with a patient in ventral decubitus position on this support,

FIG. 5 is a lower view of the assembly shown in FIG. 4,

FIG. 6 is a lateral view of the assembly shown in FIGS. 4 and 5, and

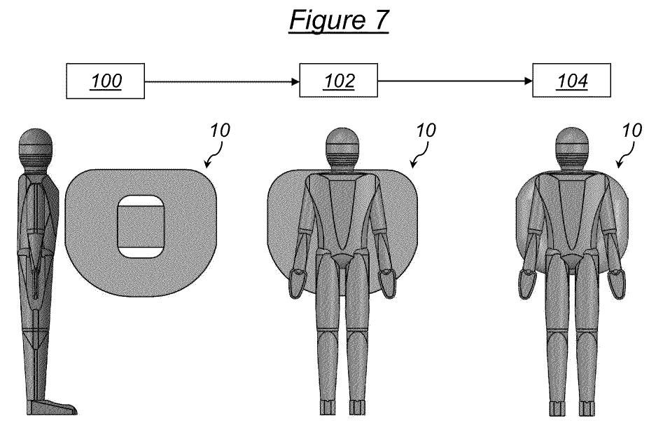

FIG. 7 illustrates the successive steps of a method for positioning a patient on the ergonomic inflatable support of FIG. 1, for a positioning for example in accordance with that of FIGS. 4, 5 and 6.

The ergonomic inflatable support 10 diagrammatically shown in perspective in FIG. 1 is illustrated in its inflated state. It is, for example, intended for medical use and has a central opening 12 shaped for at least abdominal reception of a patient in ventral decubitus position. It is even more specifically shaped to receive the abdomen and lower rib cage of this patient in the non-limiting example shown. The ergonomic inflatable support 10 could also be suitable for accommodating a patient in dorsal decubitus position. It is further intended for placement on a flat, horizontal or inclined base support, such as a bed, mattress, or any other base support suitable for a therapeutic or surgical care, monitoring or follow-up application.

The central opening 12 is bounded by an inflatable load-bearing peripheral structure 14 that completely surrounds it. In accordance with a first aspect of the present invention, this inflatable load-bearing peripheral structure 14 extends in an inflatable mainly rectangular shape with two substantially parallel lateral portions 16, 18 and also two substantially parallel transversal portions 20, 22. The first lateral portion 16, called the left lateral portion, is intended to serve as a support for the patient’s left flank, while the second lateral portion 18, called the right lateral portion, is intended to serve as a support for the patient’s right flank. The first transversal portion 20, called the upper transversal portion, is intended to serve as a support for the patient’s upper thorax, while the second transversal portion 22, called the lower transversal portion, is intended to serve as a support for the patient’s inguinal regions, more specifically the iliac crests and the root of the patient’s thighs. In accordance with a second aspect of the present invention, cooperating with the first aspect for improved ergonomics of the ergonomic inflatable support 10, the lateral and transversal portions 16, 18, 20 and 22 are shaped such that the upper transversal portion 20 has at least locally, when the inflatable load-bearing peripheral structure 14 is inflated as shown in FIG. 1, an inflated cross-section S20 of smaller dimensions than the inflated cross-sections S16 and S18 of the two lateral portions 16 and 18 for a high thoracic reception inducing a comfortable support of the chin and the base of the neck of the patient.

Optionally, the reduction in size between the upper cross-section S20 and the two lateral cross-sections S16, S18 may be sufficiently large and localized to induce an indentation, or at least a concavity slightly visible in FIG. 1, allowing improved reception of the bottom of the patient’s neck by supporting the top of the thorax and forming a gutter.

Also optionally but advantageously, the lower transversal portion 22 also has at least locally an inflated cross-section S22 of smaller dimensions than the inflated cross-sections S16 and S18 for a comfortable reception of the genitals and inguinal regions of the patient.

The cross-sections S16, S18, S20 and S22 are of any geometry, but according to a simple design, they are circular, oval, or elliptical. In a more general way, the inflatable load-bearing peripheral structure 14 is for example formed by at least one inflatable flange of plastic material provided with at least one corresponding inflation nozzle (not shown in FIG. 1). In the non-limiting but particularly ergonomic example of FIG. 1, it is formed by a single inflatable flange, for example made of polyurethane, polyvinyl chloride, polyethylene or polyamide, mainly rectangular in shape and fitted with a single inflation nozzle.

It should be noted that according to an optional but advantageous embodiment, the central opening 12 has a mainly rectangular bottom 23, integral with the inflatable load-bearing peripheral structure 14, for maintaining the mainly rectangular shape of the latter and for receiving the patient’s abdomen when the patient is in ventral decubitus position. This bottom 23 is for example made of a film of the same material as the mainly rectangular inflatable flange forming the inflatable load-bearing peripheral structure 14 and can be fixed to the latter by gluing or thermobonding. It can extend at the bottom, i.e., in contact with the base support on which the ergonomic inflatable support 10 is intended to be placed, or in the middle of the central opening 12. In the example shown in FIG. 1, it does not occupy the entire surface of the central opening 12 and is attached to the inflatable support structure 14 by its lateral portions 16 and 18.

The upper view of FIG. 2 provides a better understanding of the possible dimensions and proportions of the ergonomic inflatable support 10. First of all, the four lateral and transversal portions 16, 18, 20, 22 are mainly or almost cylindrical in shape and of different cross-sections. They are connected to each other by four corner portions of curved truncated conical profiles, the whole being shaped into a single inflatable flange whose inflation nozzle 24 extends away from the central opening 12, for example laterally from the right lateral portion 18. The complete inflation system is not shown in this figure because it is a priori consistent with known systems. It should be noted, however, that the addition of a pressure gauge to measure the pressure inside the inflatable load-bearing peripheral structure 14 could provide an indication of the pressure it exerts on the skin areas of contact with the patient. It would also allow the pressure inside the inflatable support 10 to be adjusted to provide better ergonomics and comfort for the patient.

Inflation and deflation phases, for example controlled by this pressure gauge, would also make it possible, contrary to what can be envisaged with a foam support, to vary the pressure on the support points and to limit the risks of lesions at these support points.

Advantageously, the inflatable load-bearing peripheral structure 14 of the ergonomic inflatable support 10 can be provided with a rapid emptying orifice 26, for example with an unscrewable plug, which can be placed anywhere, in particular near the inflation nozzle 24. In certain emergency situations, it can be useful to have access to the possibility of deflating the support very quickly.

In this configuration, the central opening 12 appears to be mainly rectangular in shape with rounded corners. In accordance with proportions suitable for receiving the abdominal and thoracic regions of the patient when in the ventral decubitus position, it should generally have a width, bounded by the lateral portions 16 and 18, at least 25% less than its length, bounded by the two transversal portions 20 and 22. As a non-limiting example, the width of the central opening 12 may be between 25 and 30 cm, in particular about 28 cm. Its length can for example be between 35 and 40 cm, in particular about 38 cm. These proportions and dimensions can of course be adjusted to different body shapes or morphologies of patients to be more finely designed to their characteristics. In particular, from a photo, scanner, three-dimensional reconstruction or the like, it is possible to design a support with custom dimensions and proportions. The more elongated the central opening 12 is, the more the presence of the bottom 23 is justified in order to laterally hold the inflatable load-bearing peripheral structure 14.

The cross-section S16 of the left lateral portion 16 of the inflatable load-bearing peripheral structure 14 is for example circular, with a diameter equal to 20 cm +/- 10%. The cross-section S18 of the right lateral portion 18 is, for example, equal to S16.

As for the cross-section S20 of the upper transversal portion 20, it is for example circular, with a diameter equal to 10 or 15 cm +/- 10%, i.e., three quarters or half the diameter of cross-sections S16 and S18. In order to comfortably accommodate the patient’s neck, especially the bottom of the neck, it should advantageously have a reduction in diameter of at least 20%, or even at least 25%, compared to cross-sections S16 and S18, so as to produce the desired indentation or concavity.

The cross-section S22 of the lower transversal portion 22 is for example circular and of intermediate diameter equal to 15 cm +/- 10%, that is to say an intermediate reduction of 25% compared to cross-sections S16 and S18.

These different diameters and the way in which one can progressively move from one to the other are illustrated by section A-A of FIG. 3.

The above dimensions and proportions are given only as an indication and according to average physiologies of patients generally observed. However, they are all adaptable to the real morphology of the patients and should not be interpreted as limitative.

It should also be noted that, in the example of FIGS. 1 to 3, the cross-section S20 is smaller than S22. However, these two reduced cross-sections as compared to the lateral cross-sections S16 and S18 can also be equal in a variant. This variant is even preferred in practice for some applications such as the ventral decubitus position of patients in respiratory distress.

FIG. 4 illustrates a top view of a patient in ventral decubitus position on the ergonomic inflatable support 10 and shows a relatively ideal distribution of the patient’s weight on the inflatable load-bearing peripheral structure 14. In particular, the lateral portions 16 and 18 provide support for the patient’s flanks, upper thorax, pelvis and iliac crests.

The lower view in FIG. 5 shows a configuration wherein the central opening 12 is sized to accommodate the patient’s abdomen and even a portion of the patient’s (lower) thoracic and even (upper) pelvic regions. The upper transversal portion 20 advantageously supports the top of the patient’s sternum for an optimized positioning of his/her chin and the base of his/her neck. The lower transversal portion 22 advantageously supports the patient’s iliac crests in the inguinal region.

The lateral view of FIG. 6 shows that it may be optionally advantageous to design the ergonomic inflatable support 10 in a transparent plastic material, polyurethane, polyvinyl chloride, polyethylene, polyamide or other. This makes it possible to check that the patient is properly positioned and that the abdominal portion is free. This view also shows that the bottom 23 extends on the sides of the lateral portions 16 and 18 to optimize their support. Finally, it shows that according to a good positioning of the patient, it is precisely his/her iliac crests and the top of his/her sternum that are supported by the transversal portions 20 and 22.

A method for positioning a patient on the ergonomic inflatable support 10 will now be detailed with reference to FIG. 7.

In a first step 100, the patient is first placed in lateral decubitus position on a base support, such as a bed, mattress or any other support suitable for follow-up, monitoring or care in therapeutic application, or even for a surgical procedure in the operating room. The ergonomic inflatable support 10 is for example arranged deflated next to the patient on the base support. Alternatively, it could be attached deflated to the patient’s ventral part. Alternatively, the patient could also be placed in dorsal decubitus position beforehand.

In a subsequent step 102, the patient is returned to the deflated ergonomic inflatable support 10 in ventral decubitus position.

Finally, during a step 104, the ergonomic inflatable support 10 is inflated, advantageously raising the patient progressively while maintaining his/her position and freeing his/her abdominal region for a comfortable ventral decubitus position and with greatly reduced risks of bedsores. During this final step, it is possible to envisage inflation and deflation phases, as mentioned above, to vary the pressure on the patient’s support points. A headrest, such as one of those proposed in the state of the art, can be added for a better comfort.

It clearly appears that an ergonomic inflatable decubitus positioning support for medical use such as the one described above makes it possible to envisage an easy and comfortable raising of a patient, in particular a patient suffering from respiratory difficulties such as those which are symptomatic of COVID-19. But beyond this application, many other therapeutic or surgical uses can be envisaged for this ergonomic inflatable support.

It should also be noted that the invention is not limited to the embodiments described or contemplated above. Indeed, it will appear to those skilled in the art that various modifications can be made thereto, in the light of the teaching just disclosed. In the foregoing detailed presentation of the invention, the terms used are not to be construed as limiting the invention to the embodiments set forth in the present description, but are to be construed to include all equivalents the anticipation of which is within the reach of those skilled in the art by applying their general knowledge to the implementation of the teaching that has just been disclosed to them.

1. An ergonomic inflatable decubitus positioning support for medical use comprising:
a central opening shaped for at least abdominal reception of a patient in ventral decubitus position; and
an inflatable load-bearing peripheral structure surrounding the central opening,
wherein the inflatable load-bearing peripheral structure extends according to a mainly rectangular inflatable shape with two mainly cylindrical lateral portions and two mainly cylindrical transversal portions so as to obtain a mainly rectangular shape of the central opening, wherein the two mainly cylindrical lateral and transversal portions are further shaped in such a way that one of the two transversal portions, forming an upper transversal portion, has at least locally, when the load-bearing peripheral structure is inflated, an inflated cylinder cross-section of smaller dimensions than those of the inflated cylinder cross-sections of the two mainly cylindrical lateral portions for an upper thoracic reception of the patient.

2. The ergonomic inflatable support as claimed in claim 1, wherein the two mainly cylindrical lateral and transversal portions of the inflatable load-bearing peripheral structure are furthermore shaped such that the other one of the two transversal portions, forming a lower transversal portion, has at least locally, when the load-bearing peripheral structure is inflated, an inflated cylinder cross-section of smaller dimensions than those of the inflated cylinder cross-sections of the two mainly cylindrical lateral portions for reception of inguinal regions of the patient.

3. The ergonomic inflatable support as claimed in claim 1, wherein the upper transversal portion has, when inflated, an indentation or concavity for receiving the bottom of the patient’s neck and chin.

4. The ergonomic inflatable support as claimed in claim 1, wherein the inflated cylinder cross-section of the upper transversal portion has dimensions, at least locally, at least 20% smaller than those of the inflated cylinder cross-sections of the two mainly cylindrical lateral portions.

5. The ergonomic inflatable support as claimed in claim 1 wherein the main rectangular shape of the central opening is at least 25% less in width, bounded by said two lateral portions, than in length, bounded by said two mainly cylindrical transversal portions.

6. The ergonomic inflatable support as claimed in claim 1, wherein the inflatable load-bearing peripheral structure comprises at least one inflatable flange and at least one corresponding inflation nozzle and extending away from the central opening.

7. The ergonomic inflatable support as claimed in claim 1, wherein the inflatable load-bearing peripheral structure comprises a single inflatable flange of mainly rectangular shape and a single inflation nozzle disposed and extending laterally away from the central opening.

8. The ergonomic inflatable support as claimed in claim 1 wherein the central opening has a mainly rectangular bottom integral with the inflatable load-bearing peripheral structure, for maintaining the mainly rectangular shape of the latter and for receiving the patient’s abdomen when in ventral decubitus position.

9. The ergonomic inflatable support as claimed in claim 1, wherein the central opening is between 25 and 30 cm width and 35 to 40 cm length, to accommodate the abdominal and thoracic regions of the patient when in ventral decubitus position.

10. The ergonomic inflatable support as claimed in claim 1, designed in a transparent plastic material.

11. The ergonomic inflatable support as claimed in claim 4, wherein the inflated cylinder cross-section of the upper transversal portion has dimensions, at least locally, at least 25% smaller than those of the inflated cylinder cross-sections of the two mainly cylindrical lateral portions.
